(19) United States
(12) Patent Application Publication
(10) Pub. No.: US 2016/0023304 A1
(43) Pub. Date: Jan. 28, 2016

(54) METHOD FOR FORMING THREE-DIMENSIONAL ANCHORING STRUCTURES ON A SURFACE

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/341,889

(22) Filed: Jul. 28, 2014

(51) Int. Cl. B23K 26/00

(52) U.S. Cl. CPC B23K 26/0081; B23K 26/0084; B23K 26/0012; B23K 26/0078

(57) ABSTRACT

A method including: forming a melt pool (16) on a solid surface (12); applying an energy beam (10) to melt solid material (18) adjacent the melt pool; controlling the energy beam such that the melting of the solid material adjacent the melt pool creates a wave front (22) in the melt pool effective to form a protrusion (20) of material upon solidification.

### FIELD OF THE INVENTION

Aspects of the present invention relate to thermal barrier coating systems for components exposed to high temperatures, such as encountered in the environment of a combustion turbine engine. More particularly, aspects of the present invention are directed to techniques that control laser irradiation to form three-dimensional structures that are effective to improve adherence of a layer applied to the textured surface.

### BACKGROUND OF THE INVENTION

It is known that the efficiency of a combustion turbine engine improves as the firing temperature of the combustion gas is increased. As the firing temperatures increase, the high temperature durability of components of the turbine must increase correspondingly. Although nickel and cobalt based superalloy materials may be used for components in the hot gas flow path, such as combustor transition pieces and turbine rotating and stationary blades, even these superalloy materials are not capable of surviving long term operation at temperatures that sometimes can exceed 1,600degrees C.

In many applications, a metal substrate is coated with a ceramic insulating material, such as a thermal barrier coating (TBC), to reduce the service temperature of the underlying metal and to reduce the magnitude of temperature transients to which the metal is exposed. TBCs have played a substantial role in realizing improvements in turbine efficiency. However, one basic physical reality that cannot be overlooked is that the thermal barrier coating will only protect the substrate so long as the coating remains substantially intact on the surface of a given component through the life of that component.

High stresses that may develop due to high velocity ballistic impacts by foreign objects and/or differential thermal expansion can lead to damage and even total removal of the TBC (spallation) from the component. It is known to control a roughness parameter of a surface in order to improve the adhesion of an overlying thermal barrier coating. U.S. Pat. No. 5,419,971 describes a laser ablation process where removal of material by direct vaporization (e.g., without melting of material) is purportedly used to form three-dimensional structures at the surface being irradiated. Thus, such structures are generally limited to shallow patterns at the surface being irradiated (e.g., do not generally form structures extending outside the surface) and thus processes that can provide improved structural formations conducive to enhanced adhesion are needed.

### BRIEF DESCRIPTION OF THE DRAWINGS

The invention is explained in the following description in view of the drawings that show:

FIG. 1 is a side cross sectional schematic view depicting formation of an exemplary embodiment of a melt pool.

FIG. 2 is a side cross sectional schematic view depicting splash formation in an alternate exemplary embodiment of a melt pool.

FIG. 3 is a top schematic view of an exemplary embodiment of a method of forming the melt pool.

FIG. 4 is a top schematic view of an alternate exemplary embodiment of a method of forming the melt pool.

### DETAILED DESCRIPTION OF THE INVENTION

In accordance with one or more embodiments of the present invention, structural arrangements and/or techniques conducive to formation of three-dimensional anchoring structures on a surface exposed to controlled energy beam are described herein. In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understand by one skilled in the art have not been described in detail to avoid unnecessary and burdensome explanation.

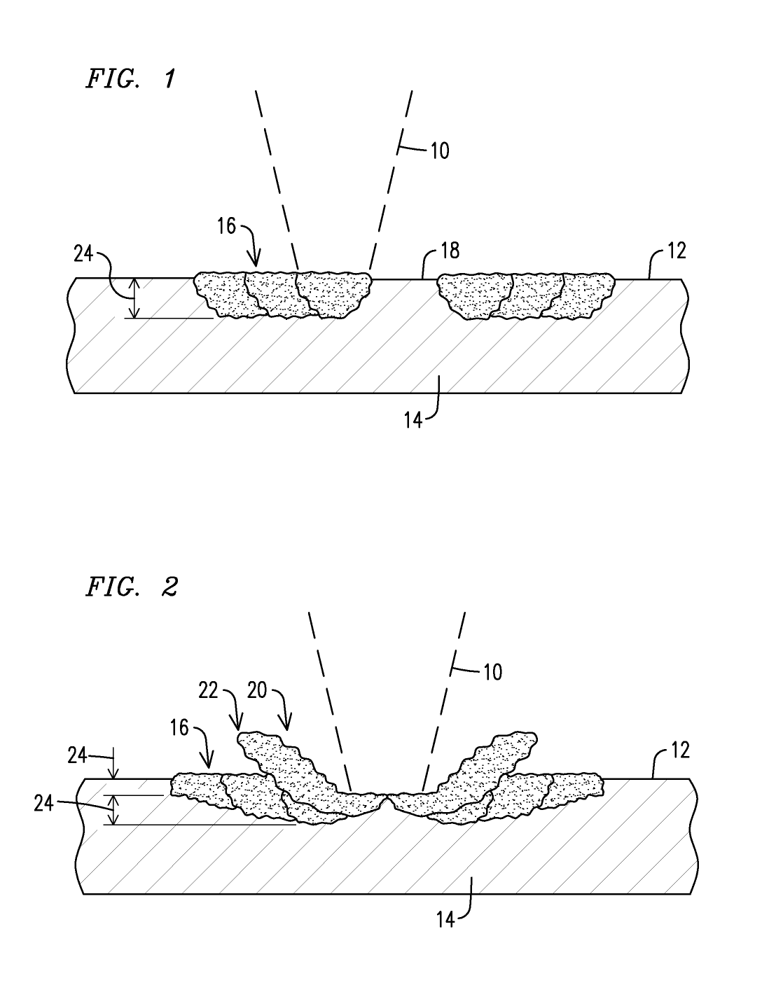

The inventors propose innovative utilization of an energy beam to form three-dimensional anchoring structures on a surface. In one non-limiting embodiment, as shown in FIGS. 1 and 2, an energy beam 10 (for example, a laser beam such as one produced by a carbon dioxide, yttrium aluminum garnet, diode, ytterbium fiber, slab or disk laser) may be applied to a surface 12 of a solid material 14 to first form a melt pool 16 of the material on the surface of the solid material. The energy beam 10 may be arranged to melt a relatively shallow layer on the surface 12 of the solid material. Before solidification of the melt pool 16, a single pulse of the energy beam 10 may be applied to solid material 18 adjacent the melt pool 16 to cause a disruption in the melt pool 16. Such a disruption may form a protrusion 20 that extends above the surface 12 of the solid material 14. Examples of protrusions 20 include a splash, a wave, a column, or a ripple etc. of liquefied material. The effect of the pulsed energy beam 10 may be conceptually analogized to a rock (high-energy pulse) being dropped onto a pool of water (melt pool 16). The protrusion 20 may form a wave front 22 and the disruption propagates through the melt pool 16. The protrusion 20 and then the melt pool 16 solidify before returning to an undisturbed liquid pool level to form a three dimensional anchoring structure that extends above the surface 12. Consequently, the three dimensional anchoring structure includes the solidified protrusion 20 and any other shapes such as ripples, recesses, etc. formed in the melt pool 16 upon solidification. In addition to providing an anchor for a subsequently applied layer, the three dimensional anchoring structures may offer increased thermal conduction (akin to fins in radiators), improved lubricity etc. The energy beam 10 used to form the melt pool 16 may be defocused or have a sufficiently low and controlled power density to cause melting to only a desired and controlled depth 24. In the exemplary embodiment of FIG. 1, the depth 24 may be essentially constant. In the alternate exemplary embodiment of FIG. 2, the depth may not be constant, but instead may vary. For example, the depth 24 may vary from being relatively deeper proximate the solid material 18 adjacent the melt pool 16 and may be become less deep with distance from the solid material 18 adjacent the melt pool 16. This configuration may cause the wave front 22 to curl as the wave front propagates outward across the melt pool 16 in a manner similar to a wave curling before crashing to a beach. This curl becomes part of the three dimensional anchoring structure and is effective to anchor any layer subsequently applied to the surface 12 of the solid material 14.

The energy beam 10 pulse used to melt the solid material 18 adjacent the melt pool 16 may be a focused pulse having a sufficiently high power density to melt the solid material 18 adjacent the melt pool 16 and also form the protrusion 20 in the melt pool 16 in a single pulse. The energy beam must do more than just melt the solid material 18; it must impart enough energy to form the disturbance. This disturbance may be due to localized plasma formation and flash evaporation etc. of the material or from thermal expansion effects or other phenomenon stimulated by the beam energy.

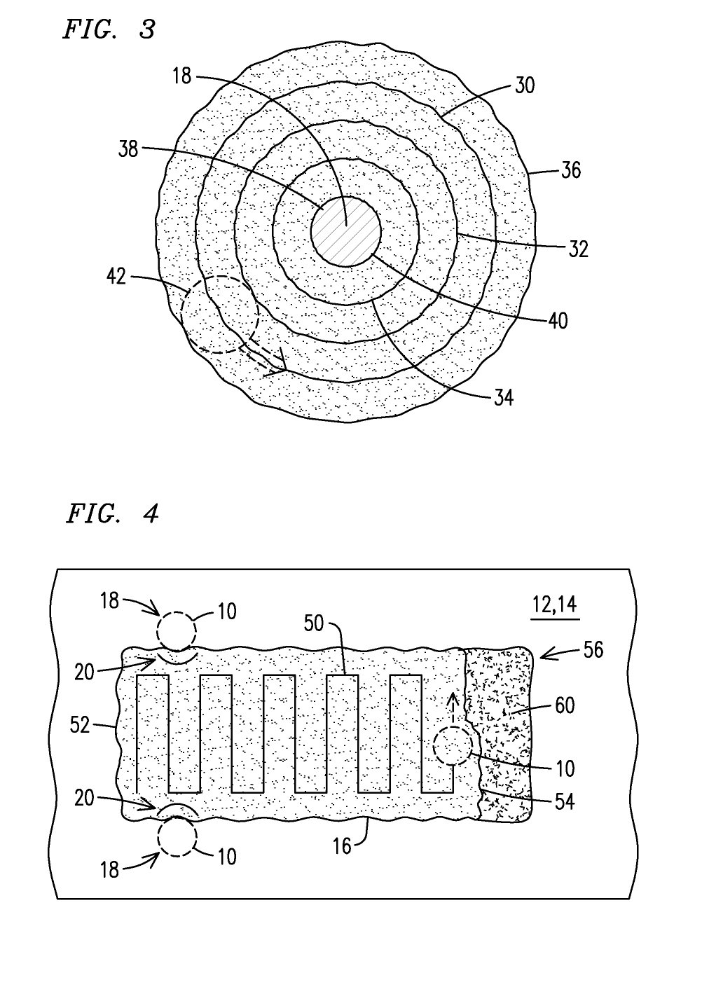

As can be seen in FIG. 3, in one non-limiting embodiment, the energy beam 10 may be applied to the surface 12 of the solid material 14 by way of a beam-scanning technique (e.g., two-dimensional scanning) of the energy beam 10 on the surface of the solid material 14, as represented by scanning circles 30, 32, 34, which are concentric in this exemplary embodiment. When the energy beam follows scanning circles 30, 32, and 34, the resulting melt pool 16 is annular-shaped and has an outside diameter of 36, an inside diameter of 38, and surrounds the solid material 18 adjacent the melt pool 16. In an exemplary embodiment a diameter of scanning circle 30 is 4 mm, a diameter of scanning circle 32 is 3 millimeters, a diameter of scanning circle 34 is 2 millimeters, the outside diameter 36 is 5 millimeters, and the inside diameter 38 is 1 mm. An overlap of the beam on adjacent scanning circles may be about fifty percent. For example, while scanning across the surface 12 to form scanning circle 32, the energy beam 10 overlaps the surface 12 that was scanned when the energy beam moved along scanning circle 30. While scanning across the surface 12 to form scanning circle 34, the energy beam 10 overlaps the surface 12 that was scanned when the energy beam moved along scanning circle 32. The depth 24 of the melt pool 16 may be controlled by controlling an amount of overlap during scans, and the overlap may range from zero percent to nearly one hundred percent. Alternately, the depth may be controlled by varying other parameters, such as power, pulse duration and/or travel speed.

In a non-limiting exemplary embodiment, when scanning to form the melt pool 16, the energy beam 10 may be a laser beam delivering a relatively low 400 watts continuous power, or a low 400 watts average power achieved by alternating relatively high, short duration power with relatively low, long duration power. Other parameters would include e.g. 0.02 to 0.20 meters/second mark speed (travel speed), a 1 millimeter beam diameter, and a fifty percent overlap. With these parameters it takes approximately 1 second to produce the annular shaped melt pool 16. When delivering the pulse that melts the solid material 18 adjacent the melt pool, (inside the annular shape in this exemplary embodiment), the energy beam 10 may be a stationary laser beam delivering a relatively high 1500 watts of power, having a frequency of 0.002 kHz, pulse length of 5000,000 microseconds, and a 1 millimeter beam diameter. With these parameters it takes approximately 0.5 seconds to melt the solid material 14 adjacent the melt pool 16 and create the protrusion.

Energy beam parameters such as the beam diameter, power levels, pulse durations, melt pool size and shape etc. may be varied during the process as desired to reach the optimum results for a given application, such as refining a size and shape of the three dimensional anchoring structure for a particular region of the surface 12 of the component being treated.

In another non-limiting exemplary embodiment, a typical energy density for general, broad area melting may range from approximately 3 kJ/cm² to approximately 10 kJ/cm². For disruption, pulses of focused energy may have respective ranges typical of laser ablation processing. Karl-Heinz Leitz et al in a paper titled “Metal Ablation with Short and Ultrashort Laser Pulses”, published in Physics Procedia, Vol. 12, 2011, pages 230-238, has summarized such ranges in parameters as follows:

| | Applied | | | Focus |
|---|---|---|---|---|
| Pulse | Power | Pulse Energy | Peak Fluence | Radius |
| 80 micro-s | 44 w | 90 milli-J | 200 micro-m | 140 J/cm² |
| 60 nano-s | 34 w | 280 micro-J | 20 micro-m | 45 J/cm² |
| 10 pico-s | 7.5 w | 150 micro-J | 40 micro-m | 6 J/cm² |
| 170 femto-s | 300 micro-w | 300 micro-J | 30 micro-m | 23 J/cm² |

In an exemplary embodiment, the scanning motion of the energy beam 10 may be accomplished using laser scanning optics (e.g. galvanometer driven mirrors) and commensurate optics control software and controller(s). Moving the surface 12 with respect to a stationary energy beam 10 would be another alternative to provide beam scanning. It will be appreciated that energy beam 10 need not be applied by way of a beam-scanning technique. For example, a non-scanning energy beam (e.g., from a diode laser) may be used to form melt pool 16. The two applications of energy may be delivered by different sources, such as by different lasers, or by the same source controlled to vary its energy density and/or focus. Available 3D scanning optics also permit modulation of focal condition. The larger melt may then be achieved with a slightly defocused beam while the intense pulse may be achieved with a beam at or near focus. The foregoing process may be iteratively performed throughout the surface 12 to form a large number of three-dimensional anchoring structures on such a surface 12. Moreover, three-dimensional anchoring structures may be selectively distributed throughout the surface 12. For example, surface regions expected to encounter a relatively large level of stress may be engineered to include a larger number of three-dimensional anchoring structures per unit area compared to surface regions expected to encounter a relatively lower level of stress.

The surface to be textured may be a substrate such as a superalloy used in a gas turbine engine component. Typical superalloys for use in the preferred embodiment of surface modification include, but are not limited to, CM 247, Rene 80, Rene 142, Rene N5, Inconel-718, X760, 738. 792, and 939, PWA 1483 and 1484, C263, ECY 768, CMSX-4 and X45. In such case, the protrusions will be formed in the superalloy substrate and may act to improve adherence of a bond coat applied to the superalloy substrate.

Alternately, or in addition, the surface to be textured may be a bond coat (e.g. an MCrAlY material) that has been applied to a superalloy substrate. In this case, the protrusions will be formed in the bond coat and may act to improve adherence of a thermal barrier coating (TBC) applied to the bond coat. However, the preceding examples are not meant to be limiting, and the process may be applied to a variety of surfaces. The component may be a new component or a stripped and repaired component, such as a turbine blade or vane. Alternately, the substrate can be a repaired component where significant bond coat is left on the component to be refurbished. In this instance the bond coat may be textured in anticipation of the application of the TBC. In one non-limiting embodiment, presuming the surface of the solid material being subjected to the energy is a bond coating, it may be desirable that the depth 24 of melt pool 16 be controlled so that the melt pool 16 does not extend into the superalloy substrate. In one non-limiting embodiment, a thickness of the bond coating may range from approximately 150 micro-meters to approximately 300 micro-meters and the depth of the melt pool 16 may range up to 90 percent of the depth 24.

In alternative embodiments, the solid material 18 adjacent to the melt pool 16 pulse of the energy beam 10 may be disposed at a location other than inside the annular shaped melt pool 16. For example, the solid material 18 may be position at an outer periphery 40 of the melt pool 16. In this instance, the solid material 18 again melts “into” the adjacent the melt pool 16, (i.e. it enlarges and the weld pool 16), causing the disturbance to propagate through the melt pool 16 and thereby forming a protrusion 20. This protrusion 20 solidifies to become part of the three dimensional anchoring structure and may include a wave front 22 configuration such as that disclosed above.

In an exemplary embodiment, the melt pool 16 with a circular perimeter may be formed and an annular-shaped energy beam may be pulsed onto solid material adjacent the periphery of the annular-shaped melt pool 16. The annular-shaped energy beam would melt the solid material surrounding the annular-shaped melt pool 16 and the energy imparted would cause the protrusion 20, for example, the wave front 22, to propagate from the outer perimeter toward the center of the annular-shaped melt pool 16. The wave front 22 may initially have an annular shape and as the wave front 22 propagates inward a diameter of the wave front 22 would decrease. As the wave front 22 approaches the solid material 18 at the center it would begin to curl and then solidify to form the three dimensional anchoring structure.

Alternately, the melt pool 16 may not have the solid material 18 at the center, but instead may be a circular melt pool. In such an exemplary embodiment, upon reaching the center of the circular melt pool the wave front 22 would interact with itself, likely protruding even farther above the surface 12, and solidify, thereby forming the three dimensional anchoring structure.

In another exemplary embodiment, shown in FIG. 4, the energy beam 10 used to melt the solid material 18 adjacent the melt pool 16 may optionally be interspersedly applied during the applying of energy beam 10 to the surface 12 of the solid material 14. For example, the energy beam may follow a path 50 that forms a melt pool that “moves” across the surface 12. This movement is the result of the melt pool 16 solidifying at a trailing end 52 of the melt pool 16, while solid material 14 is melted by the energy beam 10 at a leading edge 54 of the melt pool 16. At a certain time during a scan, the pulse of the energy beam 10 may be focused onto solid material 18 adjacent the trailing edge 52 of the melt pool 16, which is about to solidify. This would be effective to cause a protrusion 20 at the trailing edge and, upon solidification of the protrusion 20 and the trailing edge 52 of the melt pool 16, the formation of the three-dimensional anchoring structure, while allowing the scan to continue at the leading edge 54. Pulses from the energy beam 10 may be repeatedly applied to solid material 18 proximate the trailing edge of the melt pool 16. This would be effective to create a respective plurality of three dimensional anchoring structures across the surface 12 as the melt pool 16 moves and the surface 12 re-solidifies. The melt pool 16 may be narrower than depicted, wider, or have any shape necessary. If narrower, the protrusions 20 may be closer, or may even essentially abut each other. Each melt pool 16 may form a row 56 of three dimensional structures, and there may be one row 56 or as may rows 56 as necessary.

It is contemplated that one may control environmental conditions using a suitable enclosure while performing the foregoing energy beam process. For example, depending on the needs of a given application, one may choose to perform the energy beam process under vacuum conditions in lieu of atmospheric pressure, or one may choose to introduce an inert gas or active gas in lieu of air.

It is contemplated that a flux 60 may be prepositioned on the surface 12 where the energy beam 10 is to traverse the surface 12. The flux 60 may be melted by the energy beam 10 and incorporated into the melt pool 16, where the flux 60 acts to protect the melt pool 16 from atmospheric contaminants. The flux 60 may also be formulated to enhance a viscosity of the melt pool 16, thereby optimizing the configuration of the three dimensional anchoring structure, and/or to provide a chemical composition that is beneficial to the melt pool 16 and which may contribute to desired characteristics of the three-dimensional anchoring structure. After treatment, the flux 60 may be removed by any of the well-known techniques, such as mechanical brushing, grit blasting etc.

It is contemplated that a mask may be positioned over the solid material 18 surrounded by the melt pool 16 prior to forming the melt pool 16. This would be effective to prevent the solid material 18 surrounded by the melt pool 16 from being melted when forming the melt pool 16, thereby preserving the solid material 18 for the subsequent pulse of the energy beam 10.

In the preceding detailed description, various specific details are set forth in order to provide a thorough understanding of the invention and its various embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components that would be well-understood by one skilled in the art have not been described in detail to avoid unnecessary and burdensome explanation.

Furthermore, various operations have been described as multiple discrete steps performed in a manner that is helpful for understanding embodiments of the present invention. However, the order of description should not be construed to infer that these operations must be performed in the order they are presented, nor that they are even order-dependent unless otherwise so described. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise indicated. Accordingly, it is intended that the invention be limited only by the spirit and scope of the appended claims.

The Invention claimed is:

1. A method comprising:
forming a melt pool on a solid surface;
applying an energy beam to melt solid material adjacent the melt pool;
controlling the energy beam such that the melting of the solid material adjacent the melt pool creates a wave front in the melt pool effective to form a protrusion of material upon solidification.

2. The method of claim 1, wherein the protrusion is formed at an outer periphery of the melt pool.

3. The method of claim 1, further comprising applying a flux to the solid surface before forming the melt pool.

4. The method of claim 1, further comprising using a relatively lower power energy beam to form the melt pool than used to melt the solid material adjacent the melt pool.

5. The method of claim 1, further comprising melting the solid material adjacent the melt pool during a single pulse of the energy beam.

6. The method of claim 1, further comprising forming an annular shaped melt pool around the solid material.

7. The method of claim 6, further comprising applying an annular shaped energy beam to the solid material adjacent an outer perimeter of the annular shaped melt pool.

8. The method of claim 6, further comprising forming the annular shaped melt pool by moving an energy beam in concentric circles.

9. The method of claim 1, further comprising providing one of an inert gas, a reactive gas, or vacuum conditions surrounding the solid surface during the forming step and the applying step.

10. The method of claim 1, further comprising at least one of adjusting an energy beam diameter, energy beam level, energy beam pulse duration, size of the melt pool, depth of the melt pool, shape of the melt pool, and a viscosity of the melt pool to control a size and shape of the protrusion.

11. The method of claim 1, further comprising forming the melt pool comprising a circular perimeter, and applying an annular shaped energy beam to solid material adjacent the circular perimeter.

12. A method comprising:
forming an annular shaped melt pool on a solid surface;
applying a single pulse of an energy beam to melt solid material surrounded by the melt pool;
controlling the energy beam such that the melting of the solid material surrounded by the melt pool creates a wave front in the melt pool effective to form a protrusion of material upon solidification.

13. The method of claim 12, further comprising using a relatively lower power energy beam to form the melt pool than used to melt the solid material surrounded by the melt pool.

14. The method of claim 12, further comprising controlling a depth of the melt pool effective to cause the wave front to curl as the wave front propagates.

15. The method of claim 14, further comprising forming the melt pool by scanning an energy beam across the solid surface, and varying a depth of the melt pool by controlling an amount of overlap of adjacent scans.

16. The method of claim 12, further comprising forming the melt pool by scanning an energy beam across the solid surface in concentric circles

17. The method of claim 12, further comprising positioning a mask over the solid material surrounded by the melt pool prior to forming the melt pool, effecting to prevent the solid material surrounded by the melt pool from being melted when forming the melt pool.

18. The method of claim 12, further comprising forming the melt pool using a continuous laser beam or a pulsed laser beam, and melting the solid material surrounded by the melt pool using a pulsed laser beam.

19. The method of claim 12, further comprising applying a flux to the solid surface, and incorporating the flux in the melt pool.

20. The method of claim 12, wherein at least one of a superalloy substrate and a bond coat applied to a superalloy substrate forms the solid surface.
